(19) United States
(12) Patent Application Publication
(10) Pub. No.: US 2017/0017887 A1
(43) Pub. Date: Jan. 19, 2017

(54) METHODS AND SYSTEMS FOR DETECTING FINANCIAL CRIMES IN AN ENTERPRISE

(71) Applicant: Wipro Limited, Bangalore (IN)

(72) Inventor: Hemant Manohar WARADKAR, Chinchwad (IN)

(73) Assignee: Wipro Limited

(21) Appl. No.: 14/924,830

(22) Filed: Oct. 28, 2015

(30) Foreign Application Priority Data
Jul. 17, 2015 (IN) 3655/CHE/2015

(51) Int. Cl. G06N 5/04; G06F 17/30; G06Q 20/40

(52) U.S. Cl. CPC G06N 5/04; G06Q 20/4016; G06F 17/30528; G06F 17/30525

(57) ABSTRACT

This disclosure relates generally to financial crimes and more particularly to methods and systems for detecting financial crimes in an enterprise. In one embodiment, a method for detection of financial crimes is disclosed. The method includes consolidating, via a processor, data associated with financial transactions collected from multifarious data sources. The method further includes identifying, via the processor, one or more financial crime scenarios based on correlation and interdependencies between data collected from the multifarious data sources. The method finally includes predicting in real-time, via the processor, one or more financial crimes by applying artificial intelligence and analytics to the one or more financial crime scenarios and the data collected from the multifarious data sources.

### TECHNICAL FIELD

This disclosure relates generally to financial crimes and more particularly to methods and systems for detecting financial crimes in an enterprise.

### BACKGROUND

The world has become a complex web of digital connections. This complex web has contributed to the ever growing sophistication in cybercrime, which has become much harder for enterprises to detect. The most onerous and important of such cybercrimes are financial crimes, as stringent regulations, growing demands from customers for integrity in a firm's financial dealings, and increased criminal sophistication have in conjunction created a uniquely difficult set of circumstances for the financial services sector. As a result, accurate prediction or detection of financial crimes has created immense pressure on financial firms.

In conventional methods and systems, financial firms have adopted silo approach to tackle anti money laundering, trade surveillance, market abuse, and customer due diligence. This silo approach does not mitigate the problems of financial crimes, as an enterprise wide view of the financial crime data is not provided through this approach.

### SUMMARY

In one embodiment, a method for detection of financial crimes is disclosed. The method includes consolidating, via a processor, data associated with financial transactions collected from multifarious data sources. The method further includes identifying, via the processor, at least one financial crime scenario based on correlation and interdependencies between data collected from the multifarious data sources. The method finally includes predicting in real-time, via the processor, at least one financial crime by applying artificial intelligence and analytics to the at least one financial crime scenario and the data collected from the multifarious data sources.

In another embodiment, a system for detecting financial crimes is disclosed. The system includes at least one processors and a computer-readable medium. The computer-readable medium stores instructions that, when executed by the at least one processor, cause the at least one processor to perform operations that include consolidating data associated with financial transactions collected from multifarious data sources; identifying at least one financial crime scenario based on correlation and interdependencies between data collected from the multifarious data sources; and predicting in real-time at least one financial crime by applying artificial intelligence and analytics to the at least one financial crime scenario and the data collected from the multifarious data sources.

In yet another embodiment, a non-transitory computer-readable storage medium for detecting financial crime is disclosed, which when executed by a computing device, cause the computing device to: consolidate, via a processor, data associated with financial transactions collected from multifarious data sources; identify, via the processor, at least one financial crime scenario based on correlation and interdependencies between data collected from the multifarious data sources; and predict in real-time, via the processor, at least one financial crime by applying artificial intelligence and analytics to the at least one financial crime scenario and the data collected from the multifarious data sources.

It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this disclosure, illustrate exemplary embodiments and, together with the description, serve to explain the disclosed principles.

FIG. 1 is a block diagram illustrating a system for detecting financial crimes in an enterprise, in accordance with an embodiment.

FIG. 2 is a block diagram illustrating a system for detecting financial crimes, in accordance with an exemplary embodiment.

FIG. 3 illustrates a flowchart of a method for detecting financial crimes in an enterprise, in accordance with an embodiment.

FIG. 4 illustrates a flowchart of a method for predicting financial crimes, in accordance with an embodiment.

FIG. 5 illustrates a block diagram of an exemplary computer system for implementing various embodiments.

### DETAILED DESCRIPTION

Exemplary embodiments are described with reference to the accompanying drawings. Wherever convenient, the same reference numbers are used throughout the drawings to refer to the same or like parts. While examples and features of disclosed principles are described herein, modifications, adaptations, and other implementations are possible without departing from the spirit and scope of the disclosed embodiments. It is intended that the following detailed description be considered as exemplary only, with the true scope and spirit being indicated by the following claims.

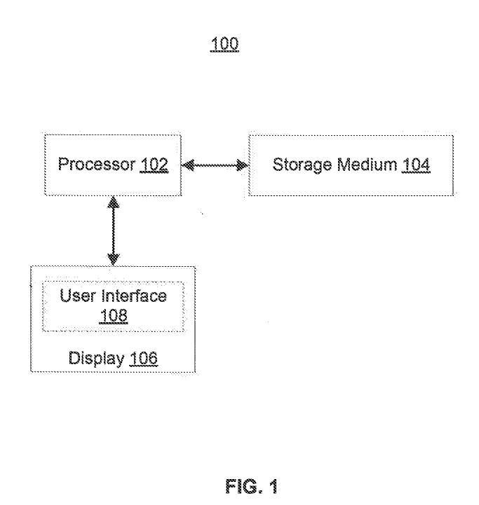

Additional illustrative embodiments are listed below. In one embodiment, a system 100 for detecting financial crimes in an enterprise is illustrated in FIG. 1, in accordance with an embodiment. In particular, system 100 is configured to detect financial crimes, without requiring any special training. System 100 includes one or more processors (for example, a processor 102), a storage medium (e.g., a memory) 104, and a display 106. Storage medium 104 stores instructions that detect financial crimes, which when executed by the one or more processors, cause the one or more processors to detect financial crimes in accordance with various embodiments. In an embodiment, storage medium 104 may be a computer readable medium. System 100 interacts with users through a user interface 108 accessible to the users via display 106.

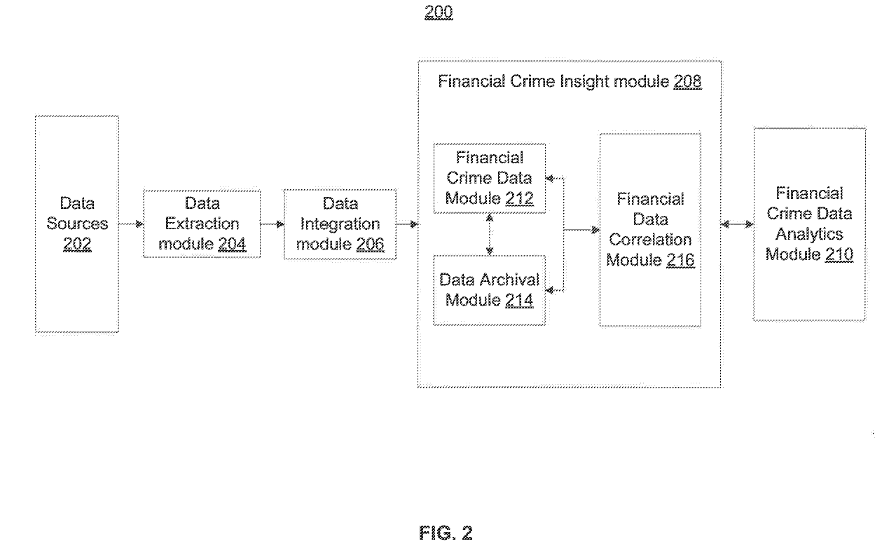

FIG. 2 is a block diagram illustrating a system 200 for detecting financial crimes, in accordance with an exemplary embodiment. System 200 includes data sources 200, a data extraction module 204, a data integration module 206, a financial crime insight module 208, and a financial crime data analytics module 210. Data extraction module 204 communicates with data sources 202 to extract data associated with financial transactions which will be used for detection of financial crimes. Data sources 202 may include multifarious data sources, for example, social media data, Know Your Customer (KYC) data, payment data, trade data, employee data, Anti Money Laundering (AML) data, market abuse data, Foreign Account Tax Compliance Act (FATCA) data, credit Bureau data, and Human Resource (HR) data. Social media data or the new age data may include, but is not limited to Twitter™ Feeds, Email communication, Facebook™ posts, LinkedIn™ updates, messaging applications, and voice data. To extract social medial data or the new age data, new age tools are used that may include, but are not limited to Flume™, Storm™, and Kafka™.

As data extraction module 204 extracts data associated with financial transactions from discrete and multifarious data sources, enhanced financial crime management can be achieved. After data extraction, data integration module 206 consolidates data associated with financial transactions collected from data sources 202. To this end, big data based systems and associated tools may be used. Examples of such tools may include, but are not limited to Java™, SQOOP™, and Secure File Transfer Protocol (SFTP™). These tools may be used to extract data from file formats that may include, but are not limited to SWIFT file format, Automatic Clearing House (ACH), MQ, Database extract, Comma Separated Values (CSV), Extensible Markup Language (XML) files, and Portable Document Format (PDF™).

The data after consolidation is received by financial crime insight module 208, which identifies one or more financial crime scenarios based on correlation and interdependencies between data collected from the multifarious data sources. Financial crime insight module 208 further includes a financial crime data module 212, a data archival module 214, and a financial data correlation module 216. Financial crime data module 212 stores the consolidated data which acts as the source for historical data feeds. Financial crime data module 212 acts as a single repository for all types of data by storing and maintaining the data at a single place. This enables different users to use the data for multiple purposes for all lines of business. In an embodiment, this consolidated data is stored at the granular level.

Financial crime data module 212 may communicate with data archival module 214 to archive some of the data collected from multifarious data sources, which may have become very historic or may have become non-active data set. This archival of data also enables regulatory compliance. Further, financial data correlation module 216 may communicate with financial crime data module 212 and data archival module 214 to identify one or more financial crime scenarios based on correlation and interdependencies between data collected from the multifarious data sources. The analysis performed to identify these financial crime scenarios may focus on historical data in order to detect crimes that were previously unnoticed. In an embodiment, financial data correlation module 216 may use the data collected from the multifarious data sources to generate alerts that trigger further in-depth or detailed analysis on the data. To this end, standard big data technologies, which may include but are not limited to Not Only SQL (NoSQL) Database, Cassandra, and Hbase may be leveraged for real time computing of data collected from multifarious data sources. These big data technologies also provide added intelligence along with quick data availability for further investigation and monitoring. Thus, financial crime insight module 208 links previously disconnected areas of financial crime data in order to explore the overlaps, synergies, and linkages between discrete data derived from multifarious sources.

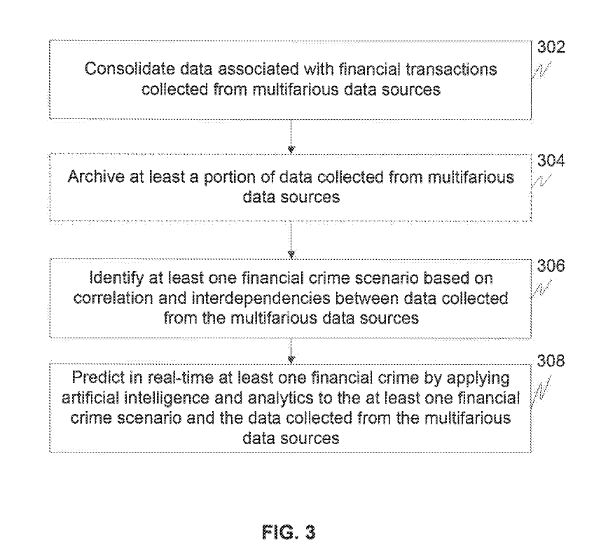

The one or more financial crime scenarios and the data collected from the multifarious data sources are then used by financial crime data analytics module 210 to predict one or more financial crimes by applying artificial intelligence and analytics in real-time. Financial crime data analytics module 210 creates insights, behavior patterns, and risk profiles for early detection of any case of non-compliance which may translate into a financial crime. Financial crime data analytics module 210 enables implementation of various use cases for proactively detecting financial crimes. To this end, financial crime data analytics module 210 creates behavioral profiles associated with each of internal employees, traders, and customers. Thereafter, each of internal employees, traders, and customers are clustered into a plurality of categories based on associated behavioral profiles and risk scores. This enables identification of high risk outliers for each of internal employees, traders, and customers. Financial crime data analytics module 210 then detects suspicious pattern within a network of individuals associated with each of the employees, traders, and customers based on associated behavioral profiles, risk scores, and a plurality of parameters. The plurality of parameters may include but are not limited to physical address of an individual, Internet Protocol (IP) address, device ID, and social media information. This is further explained in detail in conjunction with FIG. 3.

FIG. 3 illustrates a flowchart of a method for detecting financial crimes in an enterprise, in accordance with an embodiment. Initially data associated with financial transactions is collected from discrete and multifarious data sources, which may include but are not limited to social media data, KYC data, payment data, trade data, employee data, AML data, market abuse data, FATCA data, credit Bureau data, and HR data. Social media data or the new age data may include, but is not limited to Twitter™ Feeds, Email communication, Facebook™ posts, LinkedIn™ updates, Messaging applications, and voice data. To extract social medial data or the new age data, new age tools are used that may include, but are not limited to Flume™, Storm™, and Kafka™. After extraction, the data collected from multifarious data sources is consolidated in a single place at 302. During consolidation, multi-channel and multi-structured raw data that has been extracted from multifarious data sources flows into financial crime insight module 208, where that data is operated on using workloads enabled by data OS capabilities of tools that may include, but are not limited to YARN or Mapreduce. The raw data extracted from multifarious data sources may flow into the financial crime insight module 208 in its native format as one or more of Batch data, streaming data or near real time data. This data post consolidation is stored indefinitely for compliance or audit purposes. Moreover, this data may be of use for performing unforeseen analytical analysis in the future. In an embodiment, data in financial crime insight module 208 may be consolidated using Big Data tools, for example, Hive and thus data is stored in a structured format in order to provide offline or batch mode analysis.

In an embodiment, at 304, one or more portions of the consolidated data may be archived when the data qualifies as historic data or non-active data. The step of archiving data is optional and may not be performed. After consolidation of data, one or more financial crime scenarios are identified at 306, based on correlation and interdependencies between data collected from the multifarious data sources. The correlation and interdependencies is determined by linking areas of financial crime data which in conventional systems were completely disconnected. This enables identifying the overlaps, synergies, and linkages that exist between cross-firm data sets. For example, for a given user, data extracted from Facebook™ posts or Twitter™ feeds may be used in conjunction with data associated with financial transactions made using credit or debit card of that user. In a scenario, Twitter™ feed of the user may indicate that the user is on vacation in a foreign country and a credit card transaction is made using credit card of that user in user's home country. These discrete set of data derived from different sources, when looked at in conjunction would indicate an anomaly or in other words a financial crime in execution.

To identify financial crime scenarios, standard data mining and statistical tools that may include, but are not limited to SAS, R, and Mahout, may be used on financial crime data module 212 or on NoSQL database. Additionally, for identifying the one or more financial crime scenarios, complex event processing may be performed using tools, for example, storm, to detect fraud related to real time payment transactions. In an embodiment, analytical models may be used to analyze transactional and relationship data to predict different types of fraud, ongoing fraud schemes, and discover fraud networks. In an exemplary embodiment, pre-aggregated or analytics insights received from Hbase and Hive are integrated with analysis received from Storm to predict fraudulent transactions and fraudulent events taking place in real time.

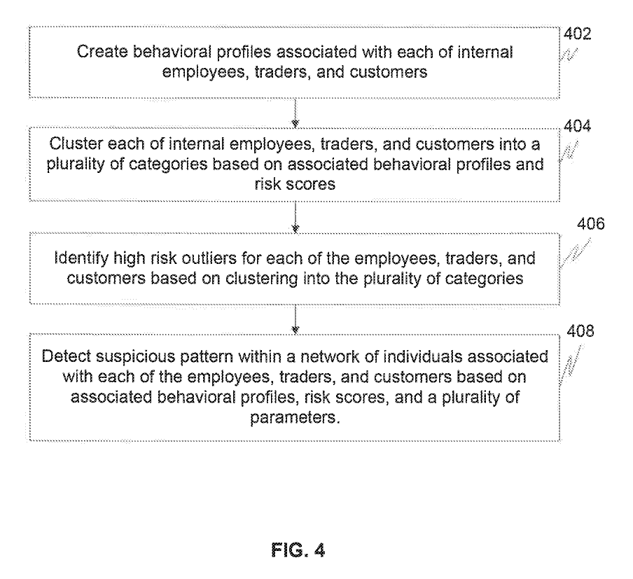

Thereafter, at 308, one or more financial crimes are predicted in real-time by applying artificial intelligence and analytics to the one or more financial crime scenarios and the data collected from the multifarious data sources. To this end, behavioral profiles associated with each of internal employees, traders, and customers are created. Predictions that are associated with internal employees are for internal organization fraud. Similarly, predictions associated with traders are for trade surveillance and predictions associated with the customers are for anti-money laundering. This is further explained in conjunction with FIG. 4.

As a result of application of artificial intelligence and analytics, in real time, on one or more financial crime scenarios and the data collected from the multifarious data sources, the prediction of financial crimes is considerably more accurate when compared with conventional systems. Additionally, use of such methods and systems reduces the cost of compliance and moves an organization beyond the path of “Minimal Compliance” by increasing the information yield. It further provides a 360 degree view of data collected from multifarious data sources to proactively identify financial crimes and also comply with FATCA requirements. As a result of real time integration of all data assets such as transactions, trade, and employee surveillance, quick turnaround time for detecting financial crimes is ensured, thereby mitigating financial loss, reputational harm, and punitive action by the regulators against a financial firm and its employees. Moreover, such systems and methods enable a financial firm to increase its cross-domain capabilities and subsequently develop a target operating model that aligns strategy, people, processes, analytics, and data capabilities to mitigate financial crimes. This increased risk and compliance management further results in an increased business outcome.

FIG. 4 illustrates a flowchart of a method for predicting financial crimes, in accordance with an embodiment. In order to predict financial crimes, data associated with internal employees, traders, and customers is analyzed. Analysis of data associated with internal employees is done to identify internal organization fraud, for traders to identify trade surveillance, and for customers to identify anti-money laundering. At 402, behavioral profiles associated with each of internal employees, traders, and customers are created. To create behavioral profiles for internal employees and traders, data that may include, but is not limited to email count, phone call count, social media interaction, vacation days, Bloomberg™ terminal log-in count, system assets leverage, and system log details for respective individuals may be used. For customers, behavioral profiles may be created using data that may include but is not limited to customer demographic data, social media interactions, transaction or payment history, and credit bureau data. Behavioral profiles of each internal employee, trader, and customer may be used to compute respective risk scores.

Thereafter, at 404 each of the internal employees, the traders, and the customers are clustered into a plurality of categories based on associated behavioral profiles, characteristics, and risk scores. To be bucketed into same category, two individuals should have similar behavioral profiles, characteristics, and risk scores. In particular, for customers, similar payment history is also one of the criteria for clustering. For example, there may be four categories, namely: zero risk category, low risk category, medium risk category, and high risk category. In an embodiment, neural networks may be used to cluster individuals into the plurality of categories.

Thereafter, at 406, high risk outliers are identified for each of the employees, traders, and customers using the plurality of categories. High risk outliers, for example, may be those who either fall in the high risk category or do not fit into any of the plurality of categories. In an embodiment, with regards to internal employees, analysis is performed on emails, content of emails for key word search, combined behavioral profile of the internal employees, and the plurality of categories. This analysis may provide high risk score which would be indicative of suspicious activity at end of the internal employee. With regards to identifying outliers among customers, the analysis to be performed includes detecting unusually high wire transfer and unusually low payment transfer by customers, detecting deviation from typical patterns, and detecting transactions that are not covered by predefined set of rules. In the case of customers, such analysis may be performed for every transaction made by each customer. In an embodiment, robust artificial intelligence techniques, for example, neural Networks may be used for performing such analysis.

Further, with regards to traders, abnormal trading patterns are identified along with abnormal price and traders with high frequency trading patterns. In an embodiment, plurality of analytical steps performed to identify high risk outliers for traders may include, but are not limited to pattern shift analysis based on historical trade data analysis, change in trading pattern for desk/role/traders, forward looking analysis based on employee behavior to detect abnormal trading activities, analysis of pricing behavior of traders to detect deviation of prices from average prices, analysis of cancelled or amended trades to identify reasons for such cancellations or amendments, analysis of text of communications that lead to execution of swap to flag suspicious phrases and verbiage in various communication media, analysis of historical trade data and payment transaction across the traders and employees to identify pattern shift, forward looking analysis by monitoring employee behavior and traders trading patterns, detecting abnormal trading activities and transaction patterns, analysis of pricing behavior for traders to detect market abuse activities, and surveillance of employee activities to detect abnormal behavior patterns.

Thereafter, at 408, suspicious patterns are detected within a network of individuals associated with each of the employees, traders, and customers. These suspicious patterns are detected based on associated behavioral profiles, risk scores, and a plurality of parameters. The plurality of parameters may include, but are limited to physical address of an individual, IP address, device ID, and social media information. With regards to internal employees and traders, suspicious patterns may be detected by linking demographic data of different internal employees. The demographic data may include residential address, phone numbers, IP address, device id, friend list on social network, social profiles, and risk scores. These suspicious patterns may help in recognition of entities and their linkage to behavioral profile in order to establish financial crimes. For example, a group of individuals may use common IP address, the group of individuals may have residential address in the same locality, or the group of individual may be on each other friends list on any social networking website. If one or more of these criteria is satisfied, it may be indicative of this group of individuals working in cohesion to execute a financial crime.

With regards to customers, suspicious pattern may be detected by scanning account and transaction data of customers to identify linkages between customers involved in money laundering. In an embodiment, new money laundering patterns may be detected by identifying patterns in customer data, predicting status of transactions as the transactions happen, reducing false positives, developing artificial intelligence by learning from past, for example, identifying unusual behaviour and detecting point of sale frauds, and using invoice text to detect over pricing of trade financing. In another embodiment, money laundering networks may be identified by analysing all accounts and customers, identifying inconspicuous relationships, providing holistic view of the customer base, detecting unknown links in network of customers, profiling social networks of customers to detect fraudulent activities. As this analysis generates insights, behavior patterns, and risk profiles, high volumes of fraud and insufficient transactions are easily identified, resulting in early detection of noncompliance.

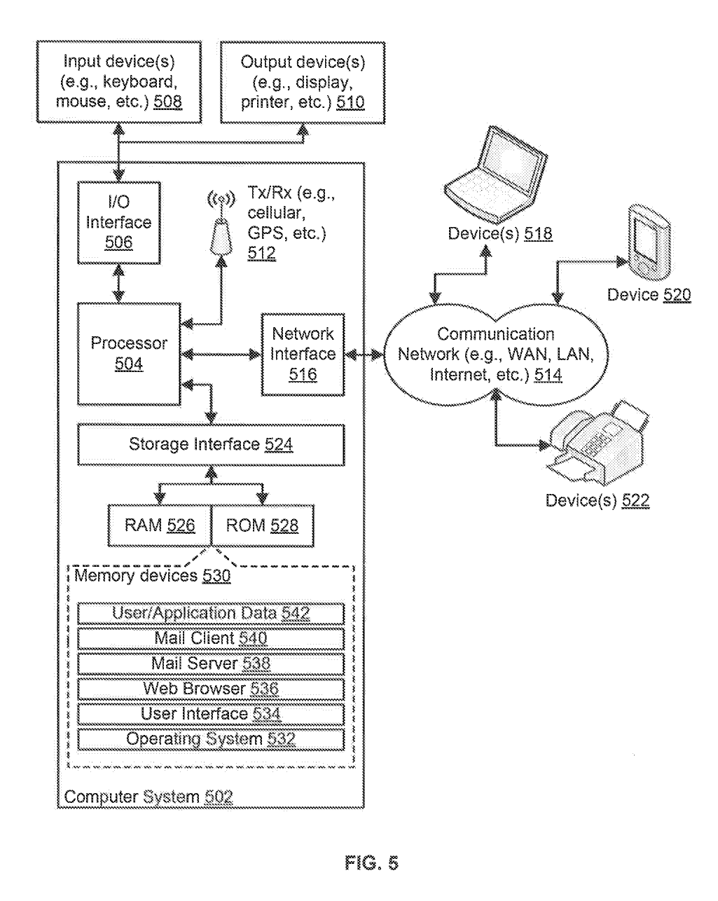

Referring now to FIG. 5, a block diagram of an exemplary computer system for implementing various embodiments is disclosed. Computer system 502 may comprise a central processing unit (“CPU” or “processor”) 504. Processor 504 may comprise at least one data processor for executing program components for executing user- or system-generated requests. A user may include a person, a person using a device such as such as those included in this disclosure, or such a device itself. The processor may include specialized processing units such as integrated system (bus) controllers, memory management control units, floating point units, graphics processing units, digital signal processing units, etc. The processor may include a microprocessor, such as AMD Athion, Duron or Opteron, ARM's application, embedded or secure processors, IBM PowerPC, Intel's Core, Itanium, Xeon, Celeron or other line of processors, etc. Processor 504 may be implemented using mainframe, distributed processor, multi-core, parallel, grid, or other architectures. Some embodiments may utilize embedded technologies like application-specific integrated circuits (ASICs), digital signal processors (DSPs), Field Programmable Gate Arrays (FPGAs), etc.

Processor 504 may be disposed in communication with one or more input/output (I/O) devices via an I/O interface 506. I/O interface 506 may employ communication protocols/methods such as, without limitation, audio, analog, digital, monoaural, RCA, stereo, IEEE-1394, serial bus, universal serial bus (USB), infrared, PS/2, BNC, coaxial, component, composite, digital visual interface (DVI), high-definition multimedia interface (HDMI), RF antennas, S-Video, VGA, IEEE 802.n /b/g/n/x, Bluetooth, cellular (e.g., code-division multiple access (CDMA), high-speed packet access (HSPA+), global system for mobile communications (GSM), long-term evolution (LTE), WiMax, or the like), etc.

Using I/O interface 506, computer system 502 may communicate with one or more I/O devices. For example, an input device 508 may be an antenna, keyboard, mouse, joystick, (infrared) remote control, camera, card reader, fax machine, dongle, biometric reader, microphone, touch screen, touchpad, trackball, sensor (e.g., accelerometer, light sensor, GPS, gyroscope, proximity sensor, or the like), stylus, scanner, storage device, transceiver, video device/source, visors, etc. An output device 510 may be a printer, fax machine, video display (e.g., cathode ray tube (CRT), liquid crystal display (LCD), light-emitting diode (LED), plasma, or the like), audio speaker, etc. In some embodiments, a transceiver 512 may be disposed in connection with processor 504. Transceiver 512 may facilitate various types of wireless transmission or reception. For example, transceiver 512 may include an antenna operatively connected to a transceiver chip (e.g., Texas Instruments WiLink WL1283, Broadcom BCM4750IUB8, Infineon Technologies X-Gold 618-PMB9800, or the like), providing IEEE 802.11a/b/g/n, Bluetooth, FM, global positioning system (GPS), 2G/3G HSDPA/HSUPA communications, etc.

In some embodiments, processor 504 may be disposed in communication with a communication network 514 via a network interface 516. Network interface 516 may communicate with communication network 514. Network interface 516 may employ connection protocols including, without limitation, direct connect, Ethernet (e.g., twisted pair 10/100/1000 Base T), transmission control protocol/internet protocol (TCP/IP), token ring, IEEE 802.11a/b/g/n/x, etc. Communication network 514 may include, without limitation, a direct interconnection, local area network (LAN), wide area network (WAN), wireless network (e.g., using Wireless Application Protocol), the Internet, etc. Using network interface 516 and communication network 514, computer system 502 may communicate with devices 518, 520, and 522. These devices may include, without limitation, personal computer(s), server(s), fax machines, printers, scanners, various mobile devices such as cellular telephones, smartphones (e.g., Apple iPhone, Blackberry, Android-based phones, etc.), tablet computers, eBook readers (Amazon Kindle, Nook, etc.), laptop computers, notebooks, gaming consoles (Microsoft Xbox, Nintendo DS, Sony PlayStation, etc.), or the like. In some embodiments, computer system 502 may itself embody one or more of these devices.

In some embodiments, processor 504 may be disposed in communication with one or more memory devices (e.g., RAM 526, ROM 528, etc.) via a storage interface 524. Storage interface 524 may connect to memory devices 530 including, without limitation, memory drives, removable disc drives, etc., employing connection protocols such as serial advanced technology attachment (SATA), integrated drive electronics (IDE), IEEE-1394, universal serial bus (USB), fiber channel, small computer systems interface (SCSI), etc. The memory drives may further include a drum, magnetic disc drive, magneto-optical drive, optical drive, redundant array of independent discs (RAID), solid-state memory devices, solid-state drives, etc.

Memory devices 530 may store a collection of program or database components, including, without limitation, an operating system 532, a user interface application 534, a web browser 536, a mail server 538, a mail client 540, a user/application data 542 (e.g., any data variables or data records discussed in this disclosure), etc. Operating system 532 may facilitate resource management and operation of the computer system 502. Examples of operating system 532 include, without limitation, Apple Macintosh OS X, Unix, Unix-like system distributions (e.g., Berkeley Software Distribution (BSD), FreeBSD, NetBSD, OpenBSD, etc.), Linux distributions (e.g., Red Hat, Ubuntu, Kubuntu, etc.), IBM OS/2, Microsoft Windows (XP, Vista/7/8, etc.), Apple iOS, Google Android, Blackberry OS, or the like. User interface 534 may facilitate display, execution, interaction, manipulation, or operation of program components through textual or graphical facilities. For example, user interfaces may provide computer interaction interface elements on a display system operatively connected to computer system 502, such as cursors, icons, check boxes, menus, scrollers, windows, widgets, etc. Graphical user interfaces (GUIs) may be employed, including, without limitation, Apple Macintosh operating systems' Aqua, IBM OS/2, Microsoft Windows (e.g., Aero, Metro, etc.), Unix X-Windows, web interface libraries (e.g., ActiveX, Java, Javascript, AJAX, HTML, Adobe Flash, etc.), or the like.

In some embodiments, computer system 502 may implement web browser 136 stored program component. Web browser 536 may be a hypertext viewing application, such as Microsoft Internet Explorer, Google Chrome, Mozilla Firefox, Apple Safari, etc. Secure web browsing may be provided using HTTPS (secure hypertext transport protocol), secure sockets layer (SSL), Transport Layer Security (TLS), etc. Web browsers may utilize facilities such as AJAX, DHTML, Adobe Flash, JavaScript, Java, application programming interfaces (APIs), etc. In some embodiments, computer system 502 may implement mail server 538 stored program component. Mail server 538 may be an Internet mail server such as Microsoft Exchange, or the like. The mail server may utilize facilities such as ASP, ActiveX, ANSI C++/C#, Microsoft .NET, CGI scripts, Java, JavaScript, PERL, PHP, Python, WebObjects, etc. The mail server may utilize communication protocols such as internet message access protocol (IMAP), messaging application programming interface (MAPI), Microsoft Exchange, post office protocol (POP), simple mail transfer protocol (SMTP), or the like. In some embodiments, computer system 502 may implement mail client 540 stored program component. Mail client 540 may be a mail viewing application, such as Apple Mail, Microsoft Entourage, Microsoft Outlook, Mozilla Thunderbird, etc.

In some embodiments, computer system 502 may store user/application data 542, such as the data, variables, records, etc. as described in this disclosure. Such databases may be implemented as fault-tolerant, relational, scalable, secure databases such as Oracle or Sybase. Alternatively, such databases may be implemented using standardized data structures, such as an array, hash, linked list, struct, structured text file (e.g., XML), table, or as object-oriented databases (e.g., using ObjectStore, Poet, Zope, etc.). Such databases may be consolidated or distributed, sometimes among the various computer systems discussed above in this disclosure. It is to be understood that the structure and operation of the any computer or database component may be combined, consolidated, or distributed in any working combination.

It will be appreciated that, for clarity purposes, the above description has described embodiments of the invention with reference to different functional units and processors. However, it will be apparent that any suitable distribution of functionality between different functional units, processors or domains may be used without detracting from the invention. For example, functionality illustrated to be performed by separate processors or controllers may be performed by the same processor or controller. Hence, references to specific functional units are only to be seen as references to suitable means for providing the described functionality, rather than indicative of a strict logical or physical structure or organization.

Various embodiments of the invention provide methods and systems for detection of financial crimes in an enterprise. As a result of application of artificial intelligence and analytics on one or more financial crime scenarios and the data collected from the multifarious data sources in real time, the prediction of financial crimes is considerably more accurate when compared with conventional systems. Additionally, use of such methods and systems reduces the cost of compliance and moves an organization beyond the path of “Minimal Compliance” by increasing the information yield. It further provides a 360 degree view of data collected from multifarious data sources to proactively identify financial crimes and also comply with FATCA requirements. As a result of real time integration of all data assets such as transactions, trade, and employee surveillance, quick turnaround time for detecting financial crimes is ensured, thereby mitigating financial loss, reputational harm, and punitive action by the regulators against a financial firm and its employees. Moreover, such systems and methods enable a financial firm to increase its cross-domain capabilities and subsequently develop a target operating model that aligns strategy, people, processes, analytics, and data capabilities to mitigate financial crimes. This increased risk and compliance management further results in an increased business outcome.

The specification has described methods and systems for IT Portfolio Transformation. The illustrated steps are set out to explain the exemplary embodiments shown, and it should be anticipated that ongoing technological development will change the manner in which particular functions are performed. These examples are presented herein for purposes of illustration, and not limitation. Further, the boundaries of the functional building blocks have been arbitrarily defined herein for the convenience of the description. Alternative boundaries can be defined so long as the specified functions and relationships thereof are appropriately performed. Alternatives (including equivalents, extensions, variations, deviations, etc., of those described herein) will be apparent to persons skilled in the relevant art(s) based on the teachings contained herein. Such alternatives fall within the scope and spirit of the disclosed embodiments.

Furthermore, one or more computer-readable storage media may be utilized in implementing embodiments consistent with the present disclosure. A computer-readable storage medium refers to any type of physical memory on which information or data readable by a processor may be stored. Thus, a computer-readable storage medium may store instructions for execution by one or more processors, including instructions for causing the processor(s) to perform steps or stages consistent with the embodiments described herein. The term “computer-readable medium” should be understood to include tangible items and exclude carrier waves and transient signals, i.e., be non-transitory. Examples include random access memory (RAM), read-only memory (ROM), volatile memory, nonvolatile memory, hard drives, CD ROMs, DVDs, flash drives, disks, and any other known physical storage media.

It is intended that the disclosure and examples be considered as exemplary only, with a true scope and spirit of disclosed embodiments being indicated by the following claims.

What is claimed is:

1. A method for detecting financial crimes, the method comprising:
consolidating, via a processor, data associated with financial transactions collected from multifarious data sources;
identifying, via the processor, at least one financial crime scenario based on correlation and interdependencies between data collected from the multifarious data sources; and
predicting in real-time, via the processor, at least one financial crime by applying artificial intelligence and analytics to the at least one financial crime scenario and the data collected from the multifarious data sources.

2. The method of claim 1, wherein the multifarious data sources are selected from a group comprising social media data, Know Your Customer (KYC) data, payment data, trade data, employee data, Anti Money Laundering (AML) data, market abuse data, Foreign Account Tax Compliance Act (FATCA) data, credit Bureau data, and Human Resource (HR) data.

3. The method of claim 1 further comprising archiving at least a portion of data collected from multifarious data sources, the at least a portion is one of historic data and non-active data.

4. The method of claim 1, wherein predicting comprises creating behavioral profiles associated with each of internal employees, traders, and customers.

5. The method of claim 4, wherein prediction corresponding to the internal employees is associated with internal organization fraud, prediction corresponding to the traders is associated with trade surveillance, and prediction corresponding to the customers is associated with anti-money laundering.

6. The method of claim 4, wherein predicting comprises clustering each of internal employees, traders, and customers into a plurality of categories based on associated behavioral profiles and risk scores.

7. The method of claim 6, wherein predicting comprises identifying high risk outliers for each of the employees, traders, and customers based on clustering into the plurality of categories.

8. The method of claim 6, wherein predicting comprises detecting suspicious pattern within a network of individuals associated with each of the employees, traders, and customers based on associated behavioral profiles, risk scores, and a plurality of parameters.

9. The method of claim 8, wherein the plurality of parameters is selected from a group comprising physical address of an individual, Internet Protocol (IP) address, device ID, and social media information.

10. A system for detecting financial crimes, the system comprising:
at least one processors; and
a computer-readable medium storing instructions that, when executed by the at least one processor, cause the at least one processor to perform operations comprising:
consolidating, via a processor, data associated with financial transactions collected from multifarious data sources;
identifying, via the processor, at least one financial crime scenario based on correlation and interdependencies between data collected from the multifarious data sources; and
predicting in real-time, via the processor, at least one financial crime by applying artificial intelligence and analytics to the at least one financial crime scenario and the data collected from the multifarious data sources.

11. The system of claim 10, wherein the multifarious data sources are selected from a group comprising social media data, Know Your Customer (KYC) data, payment data, trade data, employee data, Anti Money Laundering (AML) data, market abuse data, Foreign Account Tax Compliance Act (FATCA) data, credit Bureau data, and Human Resource (HR) data.

12. The system of claim 10, wherein the operations further comprise archiving at least a portion of data collected from multifarious data sources, the at least a portion is one of historic data and non-active data.

13. The system of claim 10, wherein the operation of predicting further comprises operation of creating behavioral profiles associated with each of internal employees, traders, and customers.

14. The system of claim 13, wherein prediction corresponding to the internal employees is associated with internal organization fraud, prediction corresponding to the traders is associated with trade surveillance, and prediction corresponding to the customers is associated with anti-money laundering.

15. The system of claim 13, wherein the operation of predicting comprises the operation of clustering each of internal employees, traders, and customers into a plurality of categories based on associated behavioral profiles and risk scores.

16. The system of claim 15, wherein the operation of predicting comprises the operation of identifying high risk outliers for each of the employees, traders, and customers based on clustering into the plurality of categories.

17. The system of claim 15, wherein the operation of predicting comprises the operation of detecting suspicious pattern within a network of individuals associated with each of the employees, traders, and customers based on associated behavioral profiles, risk scores, and a plurality of parameters.

18. The system of claim 17, wherein the plurality of parameters is selected from a group comprising physical address, Internet Protocol (IP) address, device ID, and social media information.

19. A non-transitory computer-readable storage medium for rationalizing a portfolio of assets, when executed by a computing device, cause the computing device to:
consolidate, via a processor, data associated with financial transactions collected from multifarious data sources;
identify, via the processor, at least one financial crime scenario based on correlation and interdependencies between data collected from the multifarious data sources; and
predict in real-time, via the processor, at least one financial crime by applying artificial intelligence and analytics to the at least one financial crime scenario and the data collected from the multifarious data sources.
